(19) United States
(12) Patent Application Publication
(10) Pub. No.: US 2018/0201192 A1
(43) Pub. Date: Jul. 19, 2018

(54) ALERT APPARATUS FOR VEHICLE

(71) Applicant: TOYOTA JIDOSHA KABUSHIKI KAISHA, Toyota-shi (JP)

(72) Inventor: Masaho ISHIDA, Toyota-shi (JP)

(73) Assignee: TOYOTA JIDOSHA KABUSHIKI KAISHA, Toyota-shi (JP)

(21) Appl. No.: 15/833,395

(22) Filed: Dec. 6, 2017

(30) Foreign Application Priority Data
Jan. 19, 2017 (JP) 2017-007179

(51) Int. Cl. B60R 1/08; B60Q 9/00; G08G 1/16; B60W 50/14; G01S 13/93

(52) U.S. Cl. CPC B60R 1/08; B60Q 9/008; G08G 1/167; B60R 2001/1284; B60W 50/14; G01S 13/931; G08G 1/166

(57) ABSTRACT

A Blind Spot Monitor ECU (BSM-ECU) estimates a viewable range which can be visually recognized by using a sideview mirror; determines, based on a relative position of an alert-target vehicle and the viewable range, whether or not the alert-target vehicle is present in the viewable range; when the alert-target vehicle is present in the viewable range, sets a display pattern to a viewable-vehicle display pattern; when the alert-target vehicle is not present in the viewable range, sets the display pattern to a unviewable-vehicle display pattern; and displays on an display apparatus the relative position of the alert-target vehicle with respect to an own vehicle by using the set display pattern.

### BACKGROUND OF THE INVENTION

### 1. Field of the Invention

The present disclosure relates to an alert apparatus for a vehicle. The alert apparatus is configured to inform/notify/alert a driver of presence of at least one other vehicle which travels at a position diagonally behind an own vehicle (at a rear of the own vehicle on a right side and/or a rear of the own vehicle on a left side), and which is an alert-target vehicle to be alerted/warned when the own vehicle changes lanes.

### 2. Description of the Related Art

Conventionally, as disclosed in Japanese Patent Application Laid-Open (kokai) 2001-10433 A, an alert apparatus has been known which is configured to alert a driver to presence of at least one other vehicle which travels on a lane adjacent to a lane on which an own vehicle travels. Such other vehicle includes (i) a vehicle which travels side by side with the own vehicle and travels in a blind area/spot which cannot be reflected in a sideview mirror (i.e., vehicle traveling outside of an angle of coverage of the sideview mirror), and/or (ii) a vehicle which comes close to the own vehicle from an area behind the blind area. The thus configured apparatus can alert the driver to the presence of the other vehicles (called “alert-target vehicle”), including the vehicle which travels side by side with the own vehicle in the blind area, to which the driver needs to pay attention when the own vehicle changes lanes.

Such an alert apparatus has been put into practical use, and is called a “blind-spot monitor”, for example. The blind-spot monitor includes a display apparatus provided in a part of the sideview mirror. When the alert-target vehicle has been detected, the blind-spot monitor has the display apparatus blink (flash intermittently) to alert the driver to the presence of the alert-target vehicle.

### SUMMARY OF THE INVENTION

The above-mentioned conventional alert apparatus can alert the driver (give an alert to the driver) by the blink of the display apparatus. However, the alert by the conventional alert apparatus does not identify which vehicle among other vehicles around the own vehicle has triggered the alert. For example, as shown in FIG. 11, a case may arise where one other vehicle C2 is traveling in the blind area which cannot be reflected in the sideview mirror of the own vehicle C1, and one other vehicle C3 is traveling in a mirror viewable/visible area (coverage of the sideview mirror) behind the blind area. In this situation, the driver may misguidedly recognize that the vehicle to which the alert apparatus alerts the driver at present is the “other vehicle C3” traveling in the mirror viewable area. Therefore, the driver may not notice the presence of the “other vehicle C2” in the blind area.

The present invention is made to cope with the problem described above. That is, one of objects of the present invention is to provide an alert apparatus which can have the driver recognize the presence of the alert-target vehicle appropriately.

In order to achieve the above-mentioned object, there is provided an alert apparatus (for a vehicle) according to one of embodiments of the present invention, which is configured to detect at least one other vehicle which travels at a position diagonally behind an own vehicle and which is an alert-target vehicle to be alerted when the own vehicle changes lanes, and inform a driver of presence of the alert-target vehicle.

The alert apparatus includes:

a position acquisition unit (10, 20, S11) for acquiring a relative position of the alert-target vehicle with respect to the own vehicle;

a viewable-range estimation unit (10, S14) for estimating a viewable range which the driver is able to visually recognize by using a sideview mirror, and which is an area positioned in a diagonally rearward direction (right rearward direction or left rearward direction) with respect to the own vehicle, and;

a determination unit (10, S15) for determining, based on the relative position acquired by the position acquisition unit and the viewable range estimated by the viewable-range estimation unit, whether the alert-target vehicle is a viewable vehicle which is present in the viewable range, or an unviewable vehicle which is not present in the viewable range; and

a display control unit (10, S16 to S19) for displaying on a display apparatus a display screen indicating the relative position of the alert-target vehicle with respect to the own vehicle in a plan (top) view in such a manner that the driver can distinguish between the viewable vehicle and the unviewable vehicle.

The alert apparatus for the own vehicle according to the present invention detects at least one other vehicle which travels at a position diagonally behind the own vehicle and which is the alert-target vehicle to be alerted when the own vehicle changes (or tries to change) lanes. The alert apparatus informs the driver of presence of the detected alert-target vehicle or alerts the driver to the presence of the detected alert-target vehicle. For example, by using an ambient sensor, the alert apparatus detects the alert-target vehicle(s) to be alerted when the own vehicle changes lanes among other vehicles which travel at positions diagonally behind the own vehicle. The alert apparatus informs the driver of presence of the detected alert-target vehicle(s). For example. the alert-target vehicle is a vehicle which travels on a lane adjacent to a lane on which the own vehicle travels. The alert-target vehicle includes (i) a vehicle which travels side by side with the own vehicle and travels within a blind area which is not reflected in a sideview mirror, and (ii) a vehicle which approaches the own vehicle from a position behind the blind area at a predetermined approaching level or higher level (at a vehicle speed higher than a vehicle speed of the own vehicle).

It is necessary for such an alert apparatus to have the driver suitably/appropriately recognize presence of an object to be alerted. Therefore, the alert apparatus includes the position acquisition unit, the viewable-range estimation unit, the determination unit, and the display control unit.

The position acquisition unit acquires the relative position of the alert-target vehicle with respect to the own vehicle. The viewable-range estimation unit estimates the viewable range which the driver is able to visually recognize by using the sideview mirror, and which is the range located in the diagonally rearward direction from the own vehicle. The sideview mirror is not limited to an optical mirror, and may be an electronic mirror. The electronic mirror may include a camera which takes an image/video of an area diagonally behind the own vehicle, and a display unit which displays the image obtained by the camera. Therefore, the electronic mirror is a device which allows the driver to recognize a view/landscape diagonally behind the own vehicle without turning his/her head around, similarly to the optical mirror.

The viewable range can be estimated based on an angle of the sideview mirror and a view angle of the sideview mirror, and the like. In addition, in the case of the optical mirror, it is possible to correct/modify the estimated viewable range based on a position of a driver seat to improve accuracy for estimating the viewable range. Alternatively, in the case of the electronic mirror, a part of the image obtained by the camera may be trimmed to display the trimmed image on the display unit. Further, the electronic mirror may be configured to change an area to be trimmed to adjust an angle of the electronic mirror (adjustment of a display area). In this configuration, the trimmed area may be set as the viewable range.

The determination unit determines, based on the relative position acquired by the position acquisition unit and the viewable range estimated by the viewable-range estimation unit, whether the alert-target vehicle is the viewable vehicle which is present within the viewable range or the unviewable vehicle which is not present within the viewable range. In this configuration, when the alert-target vehicle is present at a position straddling a boundary of the viewable range, the determination unit may determine that this vehicle is the viewable vehicle if this vehicle is present at such a specific position that can be substantially recognized by the driver using the sideview mirror.

The display control unit displays on the display apparatus the display screen (image) indicating the relative position of the alert-target vehicle with respect to the own vehicle in a plan view in such a manner that the driver can distinguish between the viewable vehicle and the unviewable vehicle. Therefore, even if the alert-target vehicle (the unviewable vehicle) which cannot be visually recognized by the sideview mirror and the alert-target vehicle (the viewable vehicle) which can be visually recognized by the sideview mirror are present at the same time, the driver can appropriately recognize presence of those vehicles individually.

As a result, the alert apparatus according to the present invention can have the driver recognize the presence of the alert-target vehicle appropriately.

Further, the display screen (image) indicating the relative position of the alert-target vehicle with respect to the own vehicle in a plan view does not have to be a screen which displays an exact relative position of the alert-target vehicle with respect to the own vehicle. For example, a relative positional relationship of the alert-target vehicle with respect to the own vehicle may be displayed to such an extent that the driver can determine whether the alert-target vehicle is present in immediate proximity to (is very close to) the own vehicle or far backward from the own vehicle. When a large number of the alert-target vehicles are present at the same time, the relative positions for all the alert-target vehicles do not have to be displayed. For example, only a predetermined number (two or more, e.g., two) of the alert-target vehicles may be displayed, the displayed alert-target vehicles being closer to the own vehicle than the other alert-target vehicles.

In an example of the alert apparatus of the present invention, the display control unit is configured to display on the display apparatus a first mark indicating the relative position of the viewable vehicle and a second mark indicating the relative position of the unviewable vehicle, the second mark having an alert level (caution/attention level) higher than an alert level of the first mark (FIG. 7).

According to the above example, the second mark which indicates the relative position of the unviewable vehicle and the first mark which indicates the relative position of the viewable vehicle are displayed in such a manner that the second mark has the alert level higher than the alert level of the first mark. For example, the second mark for the unviewable vehicle is blinked (intermittently flashed), whereas the first mark for the viewable vehicle is simply lighted up (maintained at a turned-ON state). In this manner, the display aspect for the unviewable vehicle and the display aspect for the viewable vehicle are different from each other. Therefore, it is possible to set the alert level for the unviewable vehicle to a higher level than that for the viewable vehicle. Alternatively, the second mark which indicates the relative position of the unviewable vehicle may be displayed in such a manner that the second mark is not present within the viewable range, and the first mark which indicates the relative position of the viewable vehicle may be displayed in such a manner that the first mark is present in the viewable range. In this manner, the alert level for the unviewable vehicle can be set to a higher level than that for the viewable vehicle.

Therefore, the alert apparatus according to the example above can have the driver recognize the presence of the alert-target vehicle in a more appropriate/suitable manner.

It should be noted that the second mark indicating the relative position of the unviewable vehicle and the first mark indicating the relative position of the viewable vehicle may be symbols which can have the driver easily recognize, the symbols representing objects to be alerted (alert-target vehicles).

In an example of the alert apparatus of the present invention, the display control unit is configured to

display on the display apparatus a viewable range area indicating the viewable range in a plan view;

display on the display apparatus the first mark indicating the viewable vehicle in such a manner that at least a part of the first mark is positioned within the viewable range area; and

display on the display apparatus the second mark indicating the unviewable vehicle in such a manner that the second mark is positioned outside of the viewable range area (FIG. 5).

According to the above example, the display control unit displays, on the display apparatus, the viewable range area (image) indicating the viewable range in a plan view, the first mark indicating the viewable vehicle, and the second mark indicating the unviewable vehicle. The first mark indicating the viewable vehicle is displayed in such a manner that at least a part of the first mark is positioned within the viewable range area. The second mark indicating the unviewable vehicle is displayed in such a manner that the second mark is positioned outside of the viewable range area (e.g., at a position close to the own vehicle). Therefore, even if the alert-target vehicle (the unviewable vehicle) which cannot be visually recognized by the sideview mirror and the alert-target vehicle (the viewable vehicle) which can be visually recognized by the sideview mirror are present at the same time, the driver can recognize presence of these vehicles at one view individually in an appropriate/suitable manner.

Further, the viewable range area displayed on the display apparatus may correspond to the viewable range estimated by the viewable-range estimation unit. Alternatively, the viewable range area displayed on the display apparatus may correspond to a predetermined viewable range (i.e., fixed range). The first mark indicating the viewable vehicle may be always displayed in such a manner that the whole of the first mark is positioned within the viewable range area.

In the above description, references used in the following descriptions regarding embodiments are added with parentheses to the elements of the present invention, in order to assist in understanding the present invention. However, those references should not be used to limit the scope of the invention.

### BRIEF DESCRIPTION OF THE DRAWINGS

FIG. 1 is a schematic diagram of an alert apparatus for vehicle according to a first embodiment of the present invention.

FIG. 2 is a front view of a sideview mirror.

FIG. 3 is a flowchart showing a BSM (Blind Spot Monitor) control routine.

FIG. 4 is a plan view showing alert-target areas in a condition 1.

FIG. 5 is a display screen D which is displayed on a right display apparatus.

FIG. 6 is the display screen D which is displayed on the right display apparatus.

FIG. 7 is a modified example of the display screen D which is displayed on the right display apparatus.

FIG. 8 is a schematic diagram of an alert apparatus for a vehicle according to a second embodiment of the present invention.

FIG. 9 is a plan view showing a display area of a right display apparatus according to the second embodiment.

FIG. 10 is a modified example of the display screen D which is displayed on the right display apparatus.

FIG. 11 is a plan view showing a positional relationship between the own vehicle and other vehicles.

### DETAILED DESCRIPTION OF THE EMBODIMENTS

Each of in-vehicle alert apparatuses according to the present invention will next be described with reference to the drawings.

### First Embodiment

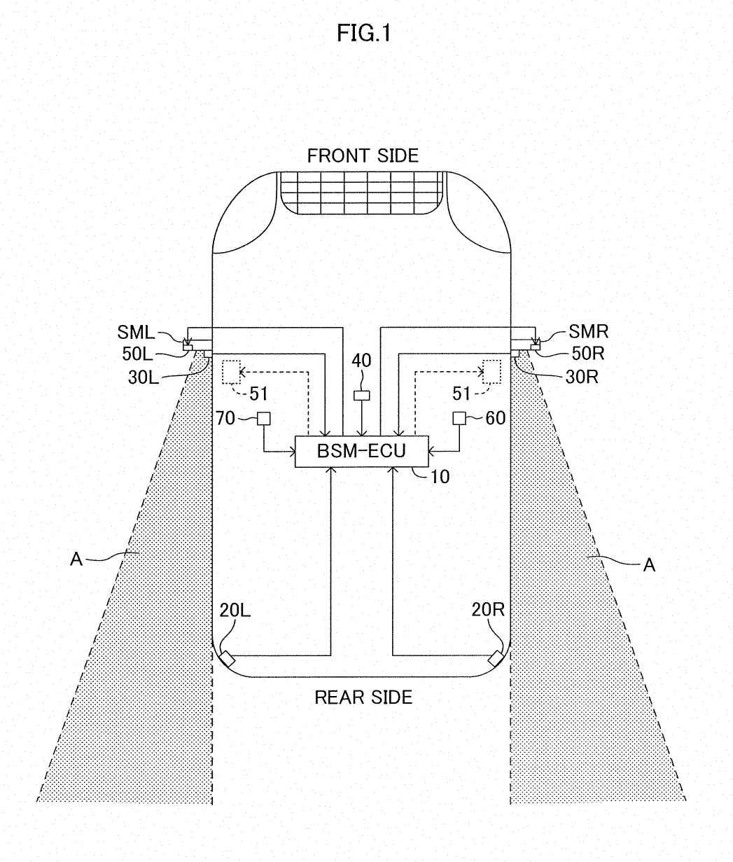

FIG. 1 shows a schematic diagram of an alert apparatus for a vehicle according to a first embodiment of the present invention. The alert apparatus is installed in (or mounted on, applied to) a vehicle (hereinafter, called an “own vehicle” in order to be distinguished from other vehicles). The alert apparatus is called a “Blind Spot Monitor”. The alert apparatus is an apparatus which informs/notifies/alerts the driver of presence of at least one other vehicle which travels at a position diagonally behind the own vehicle (at a rear of the own vehicle on a right side and/or a rear of the own vehicle on a left side), and which is a vehicle (alert-target vehicle) to be alerted/warned to the driver when the own vehicle changes lanes.

The alert apparatus comprises a Blind Spot Monitor ECU 10 including a microcomputer as a main part. Hereinafter, the Blind Spot Monitor ECU 10 is called a “BSM-ECU 10”. In the present embodiment, the microcomputer includes a CPU, a ROM, a RAM, a non-volatile memory, an interface I/F, and the like. The CPU is configured to implement various functions by executing instructions (programs, routines) stored in the ROM.

The BSM-ECU10 is connected to a right-rear ambient sensor 20R, a left-rear ambient sensor 20L, a right-mirror angle sensor 30R, a left-mirror angle sensor 30L, a sheet-position sensor 40, a right display apparatus 50R, a left display apparatus 50L, a vehicle-speed sensor 60, and a steering angle sensor 70.

The right-rear ambient sensor 20R is a radar sensor disposed at (built into) a right-rear corner part of a vehicle body. The left-rear ambient sensor 20L is a radar sensor disposed at (built into) a left-rear corner part of the vehicle body. The right-rear ambient sensor 20R and the left-rear ambient sensor 20L have the same configuration as each other, but have different detection areas (coverage areas) from each other. Hereinafter, when it is unnecessary to distinguish between the right-rear ambient sensor 20R and the left-rear ambient sensor 20L, they are collectively referred to as a “rear ambient sensor 20”.

The rear ambient sensors 20 includes a radar transmitting/receiving part (not shown) and a signal processing part (not shown). The radar transmitting/receiving part radiates a radio wave in the millimeter band (referred to as a “millimeter wave”), and receives the millimeter wave (i.e., reflected-wave) reflected by a 3D object (e.g., another vehicle, a pedestrian, a bicycle, and a building, etc.) which is present within a radiation range. The signal processing part detects the 3D object based on a phase difference between the radiated millimeter wave and the received reflected-wave, an attenuation level of the reflected-wave, a period from a time point at which the millimeter wave is radiated to a time point at which the reflected-wave is received, and the like.

The right-rear ambient sensor 20R can detect a 3D object(s) which is present in a right detection area. The right detection area has a range between a first line intersecting at a predetermined angle with a first center axis extending from the right-rear corner part of the vehicle body in a right rearward direction, and a second line intersecting with the first center axis at the predetermined angle. The left-rear ambient sensor 20L can detect a 3D object(s) which is present in a left detection area. The left detection area has a range between a third line intersecting at a predetermined angle with a second center axis extending from the left-rear corner part of the vehicle body in a left rearward direction, and a fourth line intersecting with the second center axis at the predetermined angle. The right detection area of the right-rear ambient sensor 20R includes a blind area (blind area on the right side) which cannot be reflected in a right sideview mirror SMR. Further, the left detection area of the left-rear ambient sensor 20L includes a blind area (blind area on the left side) which cannot be reflected in a left sideview mirror SML.

The rear ambient sensor 20 detects/acquires rear ambient information and transmits the detected/acquired rear ambient information to the BSM-ECU10 every time a certain time elapses. The rear ambient information includes (i) information on the detected 3D object, e.g., information on a relative positional relationship between the own vehicle and the 3D object (a direction of the 3D object with respect to the own vehicle, and a distance between the own vehicle and the 3D object), (ii) information on a relative speed between the own vehicle and the 3D object, and the like. The alert apparatus according to the present embodiment is designed/directed to inform/notify/alert the driver of presence of the alert-target vehicle which is a subject/target to be alerted when the own vehicle changes lanes. Therefore, the “3D object” is hereinafter referred as “other vehicle(s)”.

The right-mirror angle sensor 30R detects a mirror angle indicative of an orientation of the right sideview mirror SMR, and transmits information on the detected mirror angle to the BSM-ECU 10. The left-mirror angle sensor 30L detects a mirror angle indicative of an orientation of the left sideview mirror SML, and transmits information on the detected mirror angle to the BSM-ECU 10. Hereinafter, when it is unnecessary to distinguish between the right-mirror angle sensor 30R and the left-mirror angle sensor 30L, they are collectively referred as a “mirror angle sensor 30”.

In the present embodiment, the right sideview mirror SMR and the left sideview mirror SML are optical mirrors, respectively. Hereinafter, when it is unnecessary to distinguish between the right sideview mirror SMR and the left sideview mirror SML, they are collectively referred as a “sideview mirror SM”. A horizontal angle (angle measured on a horizontal plane) and a vertical angle (angle measured on a reference plane orthogonal to the horizontal plane) of the sideview mirror SM can be independently changed by using a mirror-angle adjusting apparatus (not shown) as follows. That is, the horizontal angle of the sideview mirrors SM can be changed in such a manner that a mirror surface of the sideview mirror SM rotates around a vertical axis which is substantially perpendicular to a horizontal axis. Further, the vertical angle of the sideview mirrors SM can be changed in such a manner that the mirror surface of the sideview mirror SM rotates around the horizontal axis. The mirror angle sensor 30 in the present embodiment estimates a range which the driver can visually recognize in a diagonally rearward direction (right rearward direction or left rearward direction) from the own vehicle by using the sideview mirror SM. The mirror angle sensor 30 transmits information on the estimated range to the BSM-ECU 10.

Generally, the orientation of the sideview mirror is adjusted in such a manner that the infinite position (the position of the horizon) is reflected in the sideview mirror. Within such an adjusted orientation, even if the vertical angle of the sideview mirror is slightly changed, the range diagonally behind the own vehicle which the driver can visually recognize (that is, the range which is not the blind area) is not greatly changed. In other words, another vehicle diagonally behind the own vehicle which the driver can recognize using the sideview mirror remains substantially the same regardless of the vertical angle of the sideview mirror. On the other hand, if the horizontal angle of the sideview mirror is changed, the range diagonally behind the own vehicle which the driver can visually recognize (another vehicle which is present diagonally behind the own vehicle that the driver can recognize) using the sideview mirror is greatly changed. Therefore, in the present embodiment, the BSM-ECU 10 acquires information on the horizontal angle of the sideview mirror SM from the mirror angle sensor 30.

The mirror angle sensor 30 detects the horizontal angle (angle on the horizontal plane: referred to as a “horizontal angle θm”) to which the mirror surface of the sideview mirror SM is directed with respect to a predetermined origin position of the sideview mirror SM. The mirror angle sensor 30 transmits the detected horizontal angle θm to the BSM-ECU10.

The BSM-ECU10 estimates the range (referred to as a “viewable range” or “visible range”) which the driver can visually recognize by using the sideview mirror SM. However, the viewable range changes with a position in a front-rear direction of a driver's seat and a reclining angle of the driver's seat, in addition to the horizontal angle of the sideview mirror SM. Therefore, it is preferable that the viewable range be estimated in view of these factors. In the present embodiment, the BSM-ECU 10 acquires a detection signal of the sheet-position sensor 40. In FIG. 1, two gray ranges indicated by the symbol “A” are the viewable ranges, respectively.

The sheet-position sensor 40 detects the position in the front-rear direction of the driver's seat (for example, a distance in the front-rear direction for/by which the driver's seat is moved and adjusted with respect to a predetermined origin position: referred to as an “adjusted distance LS”), and the reclining angle (for example, an angle at which a seat back of the driver's seat is inclined and adjusted with respect to a predetermined origin position: referred to as an “adjusted angle θs”). The sheet-position sensor 40 transmits to the BSM-ECU 10 the adjusted distance LS and the adjusted angle θs which are detection results.

The BSM-ECU 10 stores in advance information on the viewable range which is estimated/determined in a state in which the sideview mirror SM is set to the origin position thereof and the driver's seat is set to the origin position thereof. Hereinafter, the viewable range which is estimated in this state is referred as to an “origin-position viewable range”. This origin-position viewable range is a range corresponding to an angle of view of the sideview mirror SM.

The BSM-ECU 10 corrects/modifies the origin-position viewable range in response to the horizontal angle Om by using the origin-position viewable range and the horizontal angle θm thereby to calculate the viewable range of the sideview mirror SM whose horizontal angle has been adjusted to the horizontal angle θm. For example, the BSM-ECU 10 stores in advance a correction map/table for correcting the viewable range in response to the horizontal angle θm. The BSM-ECU 10 calculates the viewable range corresponding to the horizontal angle θm by using the correction map. Alternatively, the BSM-ECU 10 may store in advance the viewable range for each of a plurality of horizontal angles, and select the viewable range corresponding to the horizontal angle closest to the horizontal angle θm detected by the mirror angle sensor 39.

The BSM-ECU 10 further corrects/modifies the viewable range corrected in response to the horizontal angle θm based on the adjusted distance Ls and the adjusted angle θs thereby to calculate a final viewable range of the sideview mirror SM. For example, the BSM-ECU 10 stores in advance a correction map/table for correcting the viewable range in response to the adjusted distance Ls and a correction map/table for correcting the viewable range in response to the adjusted angle θs. The BSM-ECU 10 calculates the viewable range corresponding to the position of the driver's seat by using these correction maps. In this configuration, the BSM-ECU 10 may convert the adjusted angle θs into the distance in the front-rear direction of the seat. Then, the BSM-ECU 10 may calculate a moving distance of a head position of the driver in the front-rear direction with respect to the origin position when the seat back is set to the adjusted angle θs. The BSM-ECU 10 may add the moving distance to the adjusted distance Ls or subtract the moving distance from the adjusted distance Ls to calculate a modified distance LS′. The BSM-ECU 10 may calculate the viewable range by using the modified distance LS′.

Therefore, it is possible to calculate with high estimation accuracy the viewable range corresponding to the horizontal angle θm of the sideview mirror SM and the seat position (i.e., the adjusted distance Ls and the adjusted angle θs). It should be noted that the viewable range may be any range as long as at least the range in a plan view can be specified as indicated by the symbol “A” in FIG. 1.

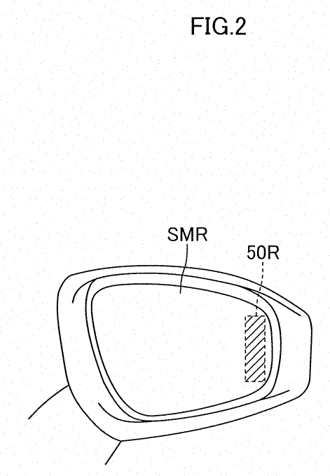

As indicated by the diagonal hatching area in FIG. 2, the right display apparatus 50R is incorporated in (built into) a part (an outer end in the vehicle-width direction: right end) of the mirror surface of the right sideview mirror SMR. The left display apparatus 50L is incorporated in (built into) a part (an outer end in the vehicle-width direction: left end) of the mirror surface of the left sideview mirror SML. The right and left sideview mirrors SMR and SML are provided in a bilaterally symmetrical manner. Therefore, the right and left display apparatuses 50R and 50L are also provided in a bilaterally symmetrical manner. The right and left display apparatuses 50R and 50L have the same configuration as each other. Hereinafter, when it is unnecessary to distinguish between the right display apparatus 50R and the left display apparatus 50L, they are collectively referred to as a “display apparatus 50”.

The display apparatus 50 is connected to the BSM-ECU 10. The display apparatus 50 displays a relative position of the alert-target vehicle with respect to the own vehicle in accordance with a display command transmitted/generated from the BSM-ECU 10.

The vehicle-speed sensor 60 detects a vehicle speed which is a running speed of the own vehicle, and transmits information on the detected vehicle speed to the BSM-ECU 10. The steering angle sensor 70 detects a steering angle, and transmits information on the detected steering angle to the BSM-ECU 10.

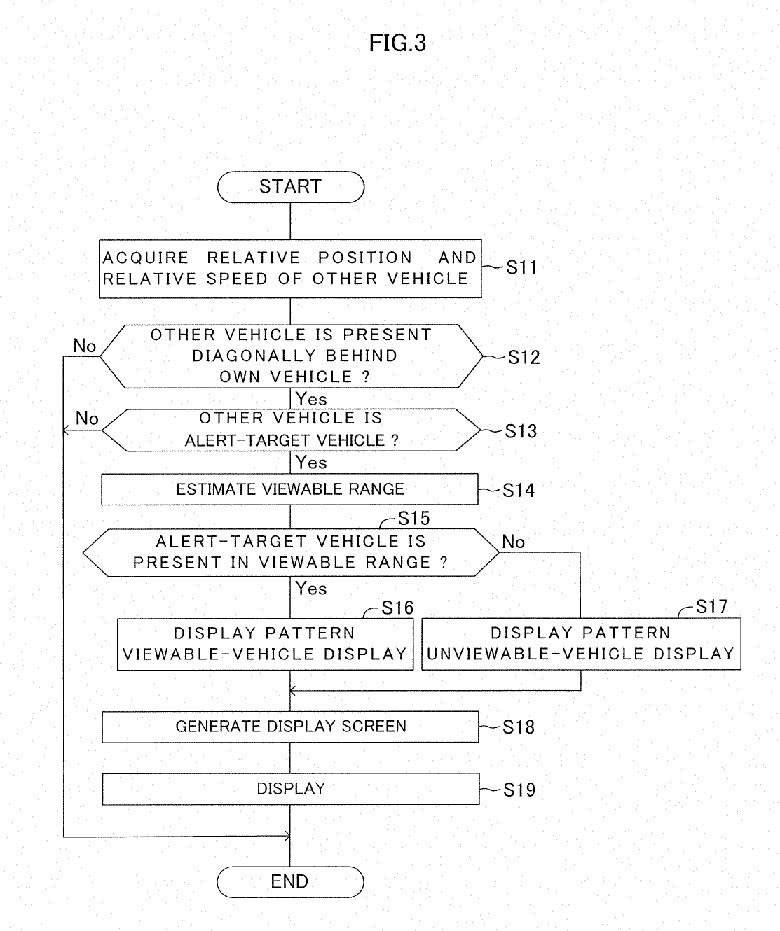

Next, a blind-spot monitoring control (referred to as a “BSM control”) executed by the BSM-ECU 10 will be described. FIG. 3 shows a BSM control routine. The BSM-ECU 10 repeatedly executes the BSM control routine every time a predetermined short time elapses.

When the BSM control routine is started, at step S11, the BSM-ECU 10 acquires the rear ambient information transmitted from each of the right and left rear ambient sensors 20R and 20L. The rear ambient information includes a relative position with respect to the own vehicle of the other vehicle(s) which is present in the vicinity of and behind the own vehicle, and a relative speed of the other vehicle(s) with respect to the own vehicle.

Next, at step S12, the BSM-ECU 10 determines whether or not at least one other vehicle is present diagonally behind the own vehicle (at the rear of the own vehicle on the right side or the rear of the own vehicle on the left side) based on the rear ambient information. That is, the BSM-ECU 10 determines whether or not at least one other vehicle is traveling on a lane (called an “adjacent lane”) which is adjacent to a lane on which the own vehicle is traveling. For example, a curve form/shape of the lane on which the own vehicle has been traveling can be estimated based on the vehicle speed detected by the vehicle-speed sensor 60 and the steering angle detected by the steering angle sensor 70. Therefore, the BSM-ECU 10 can estimate a form/shape of the adjacent lane behind the own vehicle based on the form/shape of the road on which the own vehicle has traveled. The BSM-ECU 10 can determine/specify a vehicle traveling on the adjacent lane among a plurality of other vehicles traveling behind the own vehicle, based on the form/shape of the adjacent lane behind the own vehicle. It should be noted that the BSM-ECU 10 may recognize white lines drawn on the road by using a camera and the like to detect/specify the adjacent lane. Alternatively, the BSM-ECU 10 may detect/specify the adjacent lane by using a navigation apparatus (not shown).

When no other vehicle is present diagonally behind the own vehicle (S12: No), the BSM-ECU 10 tentatively ends the BSM control routine. Further, the BSM-ECU 10 repeatedly executes the BSM control routine every time the predetermined short time elapses.

The process is repeated in this manner. When at least one other vehicle has been detected on the adjacent lane diagonally behind the own vehicle at step S12, the BSM-ECU 10 determines whether or not the detected other vehicle is the alert-target vehicle at step S13.

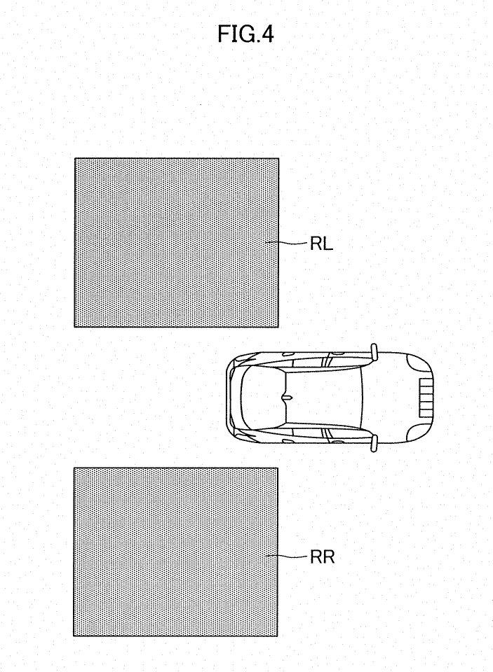

The alert-target vehicle is a vehicle to be alerted/warned when the own vehicle changes lanes. Specifically, when the other vehicle detected at step S12 meets the following two conditions, the BSM-ECU 10 treats/regards the other vehicle as the alert-target vehicle. (condition 1) At least a part of the other vehicle is included in (overlaps) any one of alert-target areas RL and RR (See FIG. 4). (condition 2) If the own vehicle changes lanes, a time (predicted collision time) to collision between the own vehicle and the other vehicle is less than a predetermined threshold.

As indicated by the symbols “RL” and “RR” in FIG. 4, each of the alert-target areas of the condition 1 is a specific region (range) which is defined relatively to the own vehicle. For example, the alert-target area is defined by (i) a first range in the vehicle-width direction from 0.5 m to 3.5 m outward from each of right and left side surfaces of the vehicle body; and (ii) a second range in the front-rear direction from 1 m forward from a rear end of the vehicle body to 4 m backward from the rear end of the vehicle body. This alert-target area should be a region suitable for a type of vehicle, and therefore, is not limited to the region defined by the above-mentioned ranges. The alert-target area in the present embodiment corresponds to a standard blind area, and thus is fixed.

Further, the condition 2 is met/satisfied when the predicted/estimated collision time (TTC (Time to Collision), i.e., estimated time to the collision between the own vehicle and the other vehicle) calculated based on the distance between the own vehicle and the other vehicle, and the relative speed of the other vehicle with respect to the own vehicle is less than a predetermined time threshold. The estimated collision time TTC is calculated by dividing the distance between the own vehicle and the other vehicle by the relative speed of the other vehicle with respect to the own vehicle. In this case, it is preferable that the estimated collision time TTC be calculated under an assumption that the own vehicle is traveling on the adjacent lane. The assumption is made by shifting the traveling position of the own vehicle by one lane width in a lane-width direction.

When the alert-target vehicle is not detected (S13: No), that is, there is no other vehicle which satisfies the above-mentioned conditions 1 and 2, the BSM-ECU 10 tentatively ends the BSM control routine. Subsequently, the BSM-ECU 10 repeatedly executes the BSM control routine every time the predetermined short time elapses. On the other hand, when there is at least one other vehicle which satisfies the above-mentioned conditions 1 and 2, the BSM-ECU 10 proceeds to step S14.

At step S14, the BSM-ECU 10 estimates the viewable range of the sideview mirror SM at/on the side (right or left side) in which the alert-target vehicle has been detected. When the alert-target vehicles are detected in both the right and left adjacent lanes, the BSM-ECU 10 estimates the viewable range for each of the right and left sideview mirrors SMR and SML. The estimation of the viewable range is made as described above. Alternatively, the BSM-ECU 10 may execute a viewable range estimation routine (not shown) in parallel with and independently/separately from the BSM control routine. In this configuration, at step S14, the BSM-ECU 10 may read the viewable range which has been estimated by the viewable range estimation routine.

Next, at step S15, the BSM-ECU 10 determines whether or not the alert-target vehicle is present in the viewable range. The BSM-ECU 10 makes the above-mentioned determination (at step S15) based on the relative position of the alert-target vehicle with respect to the own vehicle and the viewable range of the sideview mirror SM at/on the side (right or left side) in which the alert-target vehicle is present. Further, as for the alert-target vehicle which is present at a position straddling the boundary of the viewable range, if this vehicle is present at such a position that the driver can substantially recognize the vehicle by using the sideview mirror, the BSM-ECU 10 may determine that the vehicle is a “viewable vehicle”.

When the alert-target vehicle is present in the viewable range (S15: Yes), at step S16, the BSM-ECU 10 sets a display pattern about the alert-target vehicle to a “viewable-vehicle display pattern”. On the other hand, when the alert-target vehicle is not present in the viewable range (S15: No), at step S17, the BSM-ECU 10 sets the display pattern about the alert-target vehicle to an “unviewable-vehicle display pattern”. Hereinafter, the alert-target vehicle which is determined to be a vehicle traveling inside the viewable range may be referred to as a “viewable vehicle” or “visible vehicle”. Further, the alert-target vehicle which is determined to be a vehicle traveling outside the viewable range may be referred to as an “unviewable vehicle” or “invisible vehicle”.

Further, when a plurality of the alert-target vehicles have been detected, the BSM-ECU 10 sets the display pattern for each of the alert-target vehicles. That is, the BSM-ECU 10 repeatedly executes the processes in steps S15 to S17 for each of the alert-target vehicles.

After the display pattern is set in the above manner, at step S18, the BSM-ECU 10 generates a display screen (image) for displaying the relative position of the alert-target vehicle with respect to the own vehicle in a plan view. Next, at step S19, the BSM-ECU 10 displays the generated display screen (image) on the display apparatus 50 at/on the side (right or left side, or both right and left sides) in which the alert-target vehicle is present. After the process at step S19 is completed, the BSM-ECU 10 tentatively ends the BSM control routine. Further, the BSM-ECU 10 repeatedly executes the BSM control routine every time the predetermined short time elapses.

The display screen (image) displayed on the display apparatus 50 will be described. FIG. 5 shows the display screen D displayed on the right display apparatus 50R. On this display screen D, a mark/symbol M1 indicating the own vehicle, a mark/symbol M2 indicating the alert-target vehicle, and a mark/symbol ML indicating a lane boundary line (white line) are displayed. Further, on the display screen D, a mark (viewable range area) MA indicating the viewable range (in this example, the viewable range of the right sideview mirror SMR) is displayed.

On the display screen D, the relative position of the alert-target vehicle with respect to the own vehicle is displayed. Therefore, when the display pattern of the alert-target vehicle is set to the “viewable-vehicle display pattern” at step S16, the mark M2 corresponding to that alert-target vehicle is displayed in such a manner that the mark M2 is positioned within the viewable range MA (that is, at least a part of the mark M2 is positioned within the viewable range MA). On the other hand, when the display pattern of the alert-target vehicle is set to the “unviewable-vehicle display pattern” at step S17, the mark M2 corresponding to that alert-target vehicle is displayed in such a manner that the mark M2 is not positioned within the viewable range MA (the mark M2 is displayed at a position close to the mark M1 indicating the own vehicle).

In addition, the position of the mark M2 displayed on the display screen D does not have to correspond to an exact relative position with respect to the own vehicle. That is, a relative positional relationship of the alert-target vehicle with respect to the own vehicle may be displayed to such an extent that the driver can determine whether the alert-target vehicle is present in immediate proximity to the own vehicle or far backward from the own vehicle.

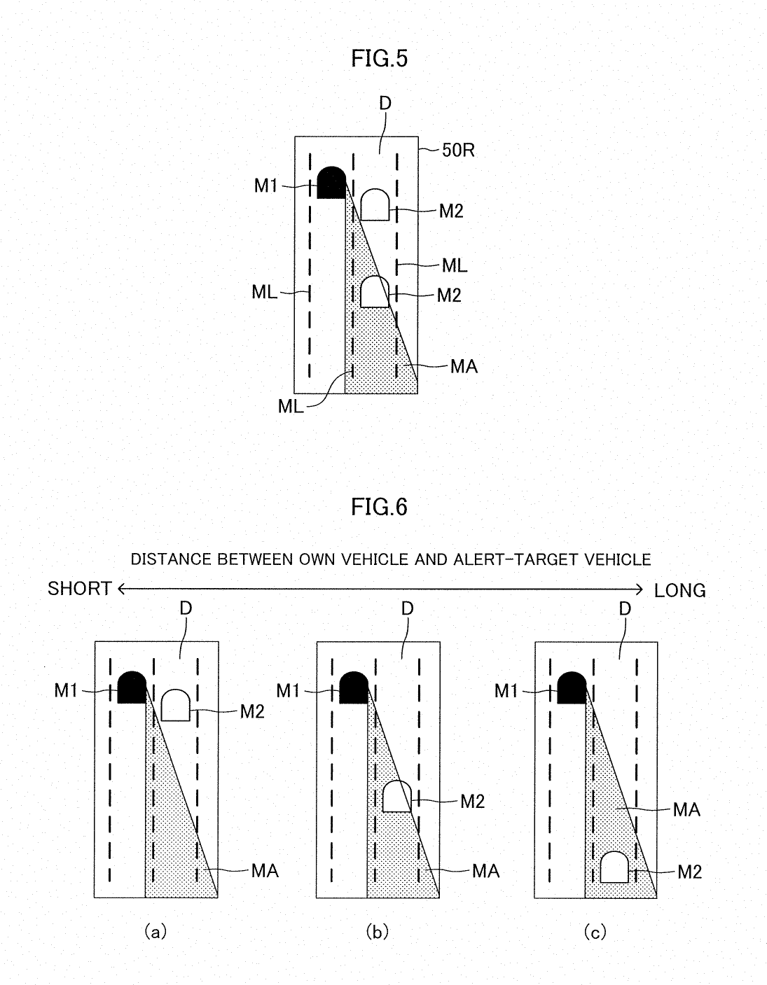

For example, as shown in FIG. 6, the BSM-ECU 10 classifies the relative positions of the alert-target vehicles with respect to the own vehicle into three patterns. When the alert-target vehicle is the “unviewable vehicle”, the BSM-ECU 10 displays the mark M2 at a position indicated in (a) of FIG. 6. When the alert-target vehicle is the “viewable vehicle” and a distance in the front-rear direction (the direction of travel of the own vehicle) between the own vehicle and the alert-target vehicle is equal to or less than a predetermined threshold, the BSM-ECU 10 displays the mark M2 at a position indicated in (b) of FIG. 6. When the alert-target vehicle is the “viewable vehicle” and the distance in the front-rear direction between the own vehicle and the alert-target vehicle is greater than the predetermined threshold, the BSM-ECU 10 displays the mark M2 at a position indicated in (c) of FIG. 6. In this example, the mark M2 is displayed at any one of three different positions. However, the mark M2 may be displayed at any one of two positions, or any one of four or more positions in response to the distance in the front-rear direction between the own vehicle and the alert-target vehicle.

Further, regarding the viewable range indicated by the mark MA, the viewable range estimated at step S14 does not have to be exactly displayed. For example, a predetermined standard range (fixed range) may be displayed as the viewable range. In this case, when the alert-target vehicle is the viewable vehicle, the display position of the mark M2 indicating the alert-target vehicle is determined in such a manner that at least a part of the mark M2 is included in (or overlaps) the range of the mark MA. In addition, regarding the viewable vehicle, the display position of the mark M2 may be determined in such a manner that the whole of the mark M2 is always included in the range of the mark MA.

When a plurality of the alert-target vehicles are present at the same time, a predetermined number (two or more, e.g., “two”) of the alert-target vehicles closer to the own vehicle than the other alert-target vehicles may be selected, and then, the marks M2 indicating the selected alert-target vehicles may be displayed. In this configuration, at step S13, the BSM-ECU 10 may select the alert-target vehicles in such a manner that the number of the marks M2 to be displayed is equal to or less than the predetermined number.

The above-described example corresponds to the display screen D displayed on the right display apparatus 50R. A display screen displayed on the left display apparatus 50L is similar to the display screen D. That is, the display screen displayed on the left display apparatus 50L and the display screen D displayed on the right display apparatus 50R are symmetrical. Therefore, on the display screen of the left display apparatus 50L, two lanes adjacent to each other are displayed, one of the two lanes being a right-side lane and the other being a left-side lane. On this screen, the mark M1 indicating the own vehicle is displayed on the right-side lane, and the mark M2 indicating the alert-target vehicle is displayed o on the left-side lane. Further, the mark MA indicating the viewable range is displayed so as to show the viewable range of the left sideview mirror SML.

On each of those display screens (including the screen D), the position of the mark M2 is changed in real time (without a delay). Therefore, the driver can look at the display screen D to recognize the alert-target vehicles while distinguishing between the viewable vehicle and the unviewable vehicle in real time. In particular, when a plurality of the alert-target vehicles are present at the same time, the driver can recognize the positional relationship between these alert-target vehicles at one view (at a glance). Further, the mark M2 corresponding to the unviewable vehicle is displayed outside of the range of the mark MA indicating the viewable area. Therefore, it is possible to alert the driver that he/she should take precautions against the unviewable vehicle at an alert level (in an emphasized manner) higher than that against the viewable vehicle. As a result, the alert apparatus according to the present embodiment can have the driver recognize the presence of the alert-target vehicles in a suitable manner.

In addition, in the present embodiment, when the alert-target vehicle has been detected, the above-described display screen on the display apparatus 50 is always displayed. However, in place of that, the above-described display screen on the display apparatus 50 may be displayed only when a direction indicator (blinker) is activated (turned ON). The BSM-ECU10 can determine whether or not the direction indicator is being activated/operated as follows. For example, the BSM-ECU 10 may input/receive a blink-monitoring signal of a blinker lamp (also called “turn-signal lamp”) to confirm whether or not the blink-monitoring signal is in the ON-state. In this configuration, between step S18 and step S19, the step for determining whether or not the blink-monitoring signal of the blinker lamp is in the ON state is inserted. At this additional step, when it is determined that the blink-monitoring signal of the blinker lamp is in the ON state, the BSM-ECU 10 may proceed to step S19. On the other hand, when it is determined that the blink-monitoring signal of the blinker lamp is in the OFF state, the BSM-ECU 10 may skip step S19 and tentatively end the BSM control routine.

Alternatively, when the alert-target vehicle has been detected, the above-described display on the display apparatus 50 may be always performed. Further, in this configuration, when the blinker is activated, the display aspect/mode of the mark may be changed in such a manner that the alert level of the mark displayed on the display apparatus 50 becomes higher. For example, when the blinker is activated, the BSM-ECU 10 may display the display screen on the display apparatus 50 with higher brightness than that in the normal situation in which the blinker is not activated. In another example, when the blinker is activated, the BSM-ECU 10 may blink the whole of the display screen.

<Modified Example of Display Aspect>

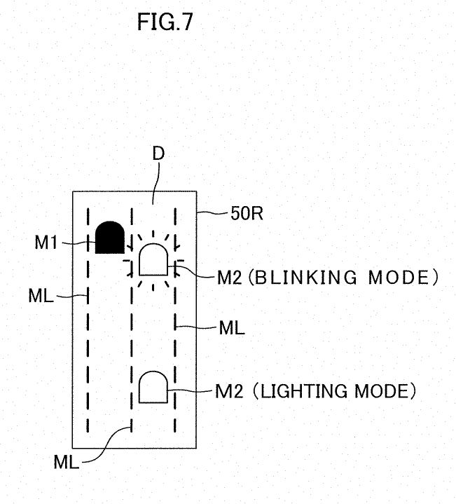

In the above-described embodiment, the mark MA indicating the viewable range and the mark M2 indicating the alert-target vehicle (corresponding to the viewable vehicle) are displayed in such a manner that they overlap with each other on the display screen D. That is, the mark M2 corresponding to the viewable vehicle is displayed in such a manner that at least a part of the mark M2 is positioned within the range of the mark MA. The mark M2 corresponding to the unviewable vehicle is displayed in such a manner that the whole of the mark M2 is positioned outside of the range of the mark MA. Therefore, the alert apparatus according to the above-described embodiment displays the display screen in such a manner that the driver can distinguish between the viewable vehicle and the unviewable vehicle. On the other hand, in this modified example, as shown in FIG. 7, the mark M2 of the alert-target vehicle which represents the relative position with respect to the own vehicle is displayed in a manner as follows. That is, when the alert-target vehicle is the unviewable vehicle, the mark M2 is displayed in a blinking mode (the mark M2 intermittently flashes). When the alert-target vehicle is the viewable vehicle, the mark M2 is displayed in a lighting mode (not blinking) in which the lighted (turned on) state is maintained.

In this modified example, when the display pattern is set to the viewable-vehicle display pattern at step S16, the BSM-ECU 10 sets the mode of the mark M2 to be displayed on the display screen D to the lighting mode at step S18. On the other hand, when the display pattern is set to the unviewable-vehicle display pattern at step S17, the BSM-ECU 10 sets the mode of the mark M2 to be displayed on the display screen D to the blinking mode at step S18.

Therefore, the driver can determine/distinguish whether the alert-target vehicle is the viewable vehicle or the unviewable vehicle based on the display aspect/appearance (in this example, blinking mode or lighting mode) of the mark M2. In particular, when a plurality of the alert-target vehicles are present at the same time, the driver can recognize the positional relationship between these alert-target vehicles at one view (at a glance). Further, the mark M2 corresponding to the unviewable vehicle is displayed in an emphasized manner, that is, by using the blinking mode having an alert level higher than that for the viewable vehicle. Therefore, it is possible to alert the driver of the unviewable vehicle in a suitable manner. As a result, the alert apparatus according to the modified example can also have the driver recognize the presence of the alert-target vehicle in a suitable manner.

In addition, the display position of the mark M2 does not have to be an exact relative position with respect to the own vehicle, similarly to the above-described embodiment. That is, a relative positional relationship of the alert-target vehicle with respect to the own vehicle may be displayed to such an extent that the driver can determine whether the alert-target vehicle is present in immediate proximity to the own vehicle or far backward from the own vehicle. For example, the mark M2 may be displayed in accordance with two or more position patterns. Further, the number of the marks M2 may be set in a similar manner to the above-described embodiment.

<Modified Example of Display Apparatus>

The above-described display apparatus 50 is provided at an outer area in the vehicle-width direction of the sideview mirror SM. However, the display apparatus 50 does not have to be provided on the sideview mirror SM. For example, as shown by the dot line in FIG. 1, the display screen D may be displayed on a display apparatus 51 provided/positioned in a vehicle interior. The display apparatus 51 is preferably provided/positioned at a position along the driver's eye direction when the driver looks at the sideview mirror SM. For example, the display apparatus 51 may be provided/positioned on an inner side of a pillar (A pillar) which is one of elements of the vehicle interior. Further, the display apparatuses 51 may be provided at both the right and left sides of a dashboard, respectively. Furthermore, the display apparatus 51 may be provided/positioned at a position close to the sideview mirror SM in each of right and left doors. In addition, the display apparatus 51 may be provided by a multi information display apparatus (display apparatus for displaying measurement values of meters/sensors and information indicating a vehicle condition) which is mounted/fixed in front of the driver's seat. In this configuration, display areas for displaying the display screen D may be provided at both right and left sides of the multi information display apparatus, respectively.

### Second Embodiment

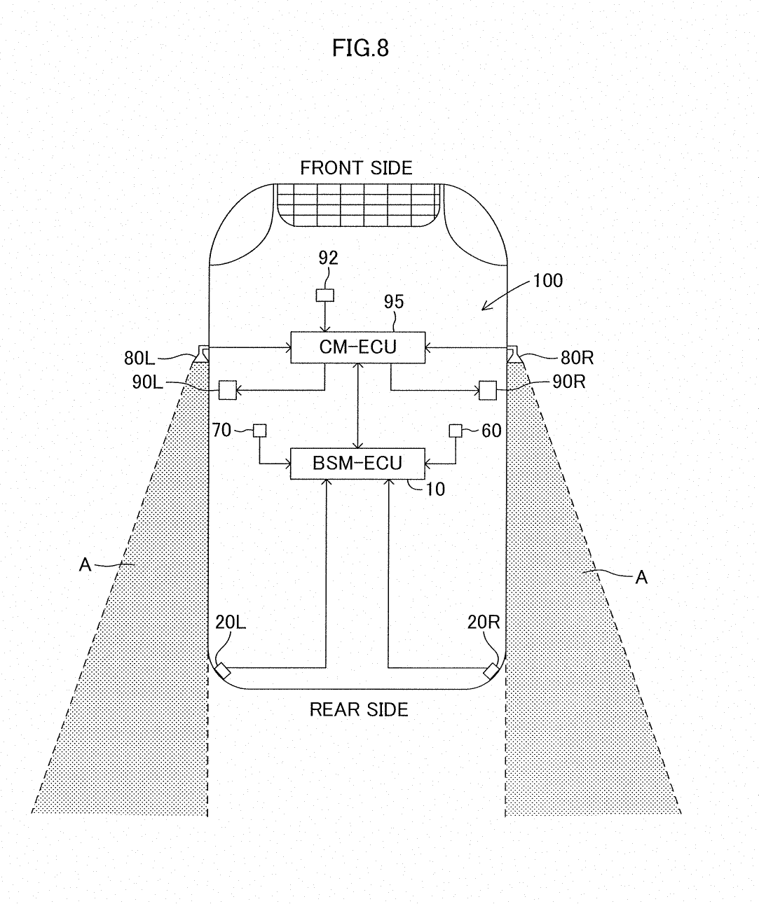

The alert apparatus according to the above-described embodiment and the modified examples thereof (hereinafter, these are collectively called a “first embodiment”) are applied to the vehicle which comprises the optical mirror as the sideview mirror. However, the alert apparatus may be applied to a vehicle which comprises an electronic mirror as the sideview mirror. FIG. 8 illustrates a schematic diagram of an alert apparatus according to a second embodiment which is applied to the vehicle comprising the electronic mirror.

The alert apparatus according to the second embodiment includes an electronic mirror 100 in place of the optical sideview mirror SM. The electronic mirror 100 includes a right-sideview camera 80R, a left-sideview camera 80L, a right display apparatus 90R, a left display apparatus 90L, an operating unit 92 for adjusting a display range, and a camera-monitoring ECU 95 (hereinafter, called a “CM-ECU 95”). The system which allows the driver to visually recognize a view behind the own vehicle by using the electronic mirror is sometimes called a “Camera Monitoring System (CMS)”.

The right-sideview camera 80R is provided/positioned at the right door or a right fender of the own vehicle, and takes an image of a right-rear side view of the own vehicle. The left-sideview camera 80L is provided/positioned at the left door or a left fender of the own vehicle, and takes an image of a left-rear side view of the own vehicle. The CM-ECU 95 is a display control device which has the right display apparatus 90R display the image obtained by the right-sideview camera 80R, and has the left display apparatus 90L display the image obtained by the left-sideview camera 80L. Hereinafter, when it is unnecessary to distinguish between the right-sideview camera 80R and the left-sideview camera 80L, they are collectively referred to as a “sideview camera 80”. Further, when it is unnecessary to distinguish between the right display apparatus 90R and the left display apparatus 90L, they are collectively referred to as a “display apparatus 90”.

The right display apparatus 90R is provided/positioned at the right-hand side of the driver in the vehicle interior. The left display apparatus 90L is provided/positioned at the left-hand side of the driver in the vehicle interior. The display apparatus 90 may be provided/positioned at any position in the vehicle interior as long as the driver can easily look at the display apparatus 90 while the driver is driving the own vehicle. For example, the display apparatuses 90 may be provided/positioned at both the right and left sides of the dashboard, respectively. Further, the display apparatuses 90 may be provided/positioned at the right and left doors, respectively. In addition, the display apparatuses 90 may be provided/positioned at the right and left pillars (A pillars), respectively. Furthermore, the display apparatuses 90 may be provided/positioned at both the right and left sides of the multi information display which is mounted in front of the driver's seat, respectively.

The CM-ECU 95 is connected to the operating unit 92 for adjusting the display range. In response to an operation of the operating unit 92 which is performed by the driver, the CM-ECU 95 independently adjusts (i) a range to be displayed on the right display apparatus 90R of the image obtained by the right-sideview camera 80R, and (ii) a range to be displayed on the left display apparatus 90L of the image obtained by the left-sideview camera 80L. That is, the sideview camera 80 takes an image with a predetermined wide range to such an extent that the taken image can cover various display ranges requested/adjusted by the driver. The CM-ECU 95 trims the range designated by the operating unit 92 from the image obtained by the sideview camera 80, and displays the trimmed range on the display apparatus 90. This range displayed on the display apparatus 90 corresponds to the “viewable range”.

The CM-ECU 95 is connected to the BSM-ECU 10 so as to transmit/receive information to/from the BSM-ECU 10. The CM-ECU 95 transmits to the BSM-ECU 10 the display range to be displayed on the display apparatus 90, that is, information on the viewable range.

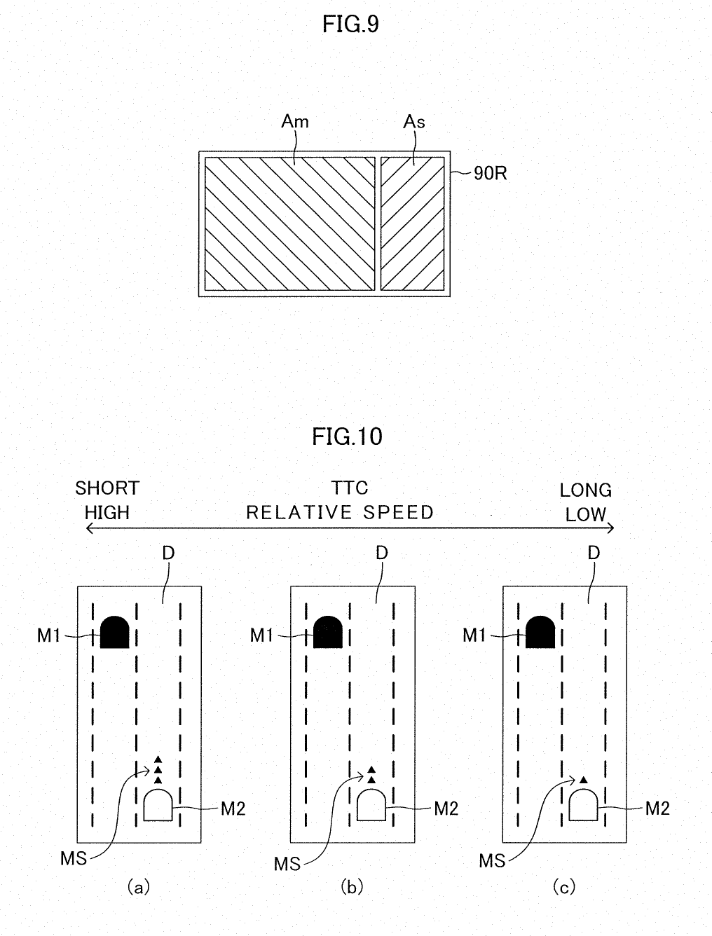

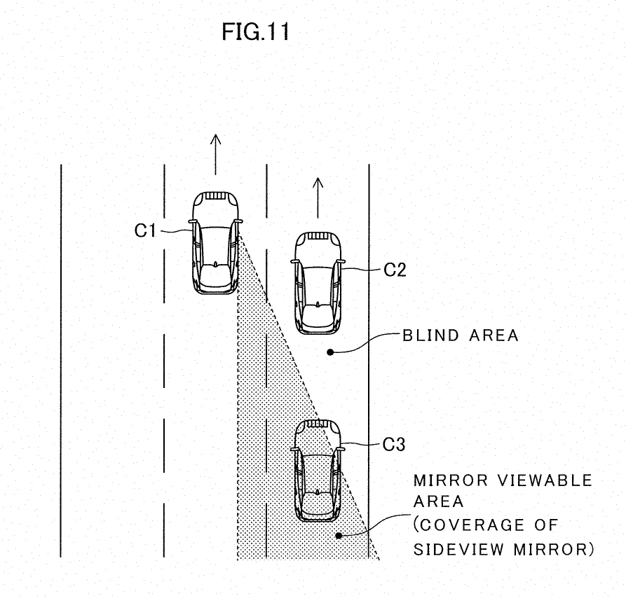

As shown in FIG. 9, the display apparatus 90 has a main display area Am and a sub-display area As. Although FIG. 9 illustrates an example of the right display apparatus 90R, a screen configuration of the left display apparatus 90L and a screen configuration of the right display apparatus 90R are symmetrical. That is, on the left display apparatus 90L, the sub-display area As is positioned on the left side of the main display area Am. The CM-ECU 95 displays on the main display area Am the image obtained by the sideview camera 80 and whose display range is adjusted by the operating unit 92. Therefore, the driver can look at the main display area Am to recognize a view/landscape diagonally behind the own vehicle similar to the view/landscape that can be visually recognized with the conventional optical sideview mirror without turning his/her head around.

The sub-display area As is an area for displaying the relative position of the alert-target vehicle with respect to the own vehicle in a plan view. The CM-ECU 95 receives image data transmitted from the BSM-ECU 10, and displays a display screen represented by the image data on the sub-display area As. This display screen displayed on the sub-display area As has a similar configuration to the display screen D of the first embodiment. That is, on the sub-display area As, the display screen D as shown in FIGS. 5 to 7 is displayed.

The BSM-ECU 10 according to the second embodiment also executes the BSM control routine shown in FIG. 3. In this case, the estimation of the viewable range is made at step S14 as follows. The BSM-ECU 10 reads the viewable range transmitted from the CM-ECU 95 (that is, the BSM-ECU 10 reads the display range of the image which has been adjusted by the operating unit 92) to thereby estimate the viewable range. Further, at step S19, the BSM-ECU 10 transmits information representing the display screen D to the CM-ECU 95. By using the information, the CM-ECU 95 displays the display screen D on the sub-display area As of the display apparatus 90. Alternatively, the BSM-ECU 10 may directly control the display on the sub-display area As without involving the CM-ECU 95.

The alert apparatus according to the above-described second embodiment can provide technical advantages/effects similar to those of the first embodiment.

In the second embodiment, the CM-ECU 95 trims the image obtained by the sideview camera 80 based on the range designated by the operating unit 92 to set the viewable range. Alternatively, the alert apparatus may include a structure for adjusting the horizontal angle and the vertical angle of the sideview camera 80. In this configuration, the CM-ECU 95 may detect the horizontal angle of the sideview camera 80 in the same way as the first embodiment, and calculate the viewable range in response to the detected horizontal angle.

Although the alert apparatuses for a vehicle according to the embodiments and modifications have been described, the present invention is not limited to the embodiments and modifications described above, and various modifications may be adopted within the scope of the present invention.

For example, regarding the display screen D shown in FIG. 5, the mark M2 corresponding to the unviewable vehicle may be displayed in a blinking manner. According to this configuration, it is possible to inform the driver of the presence of the unviewable vehicle in a more emphasized manner.

For example, on the display screen, a mark indicating the degree of the relative speed (approaching speed) of the alert-target vehicle with respect to the own vehicle, or a mark indicating the degree of the estimated collision time TTC may be additionally displayed. For example, the BSM-ECU 10 may divide the degree of the relative speed into three stages.

As shown in FIG. 10, when the relative speed is equal to or higher than a first predetermined speed threshold, the BSM-ECU 10 sets a level of an approach display mark MS to a high caution/attention level (the mark MS is a series of three triangles arranged in the travel direction as shown in FIG. 10(a)). When the relative speed is less than the first predetermined speed threshold, and is equal to or higher than a second predetermined speed threshold, the BSM-ECU 10 sets the level of the approach display mark MS to a middle caution/attention level (the mark MS is a series of two triangles arranged in the travel direction as shown in FIG. 10(b)). When the relative speed is less than the second speed predetermined threshold, the BSM-ECU 10 sets the level of the approach display mark MS to a low caution/attention level (the mark MS is one triangle as shown in FIG. 10(c)). In response to the set caution/attention level, the BSM-ECU 10 displays the approach display mark MS ahead of (above in the figure) the mark M2.

Alternatively, the BSM-ECU 10 may divide the degree of the estimated collision time(TTC) into three stages. When the TTC is shorter than a first predetermined time threshold, the BSM-ECU 10 sets the level of the approach display mark MS to the high caution/attention level. When the TTC is equal to or longer than the first predetermined time threshold, and is shorter than a second predetermined time threshold, the BSM-ECU 10 sets the level of the approach display mark MS to the middle caution/attention level. When the TTC is equal to or longer than the second predetermined time threshold, the BSM-ECU 10 sets the level of the approach display mark MS to the low caution/attention level. In response to the set caution/attention level, the BSM-ECU 10 displays the approach display mark MS ahead of (above in the figure) the mark M2.

For example, in the present embodiment, the radar sensor is used as the rear ambient sensor 20. In place of this sensor, other sensors (for example, a camera sensor and the like) may be used.

What is claimed is:

1. An alert apparatus configured to detect at least one other vehicle which travels at a position diagonally behind an own vehicle and which is an alert-target vehicle to be alerted when the own vehicle changes lanes, and inform a driver of presence of the alert-target vehicle, the alert apparatus comprising:
a position acquisition unit for acquiring a relative position of the alert-target vehicle with respect to the own vehicle;
a viewable-range estimation unit for estimating a viewable range which the driver is able to visually recognize by using a sideview mirror, and which is an area positioned in a diagonally rearward direction with respect to the own vehicle, and;
a determination unit for determining, based on the relative position acquired by the position acquisition unit and the viewable range estimated by the viewable-range estimation unit, whether the alert-target vehicle is a viewable vehicle which is present in the viewable range, or an unviewable vehicle which is not present in the viewable range; and
a display control unit for displaying on a display apparatus a display screen indicating the relative position of the alert-target vehicle with respect to the own vehicle in a plan view in such a manner that the driver can distinguish between the viewable vehicle and the unviewable vehicle.

2. The alert apparatus according to claim 1, wherein the display control unit is configured to display on the display apparatus a first mark indicating the relative position of the viewable vehicle and a second mark indicating the relative position of the unviewable vehicle, the second mark having an alert level higher than an alert level of the first mark.

3. The alert apparatus according to claim 1, wherein the display control unit is configured to:
display on the display apparatus a viewable range area indicating the viewable range in a plan view;
display on the display apparatus a first mark indicating the viewable vehicle in such a manner that at least a part of the first mark is positioned within the viewable range area; and
display on the display apparatus a second mark indicating the unviewable vehicle in such a manner that the second mark is positioned outside of the viewable range area.

4. The alert apparatus according to claim 2, wherein the display control unit is configured to
display on the display apparatus a viewable range area indicating the viewable range in a plan view;
display on the display apparatus the first mark indicating the viewable vehicle in such a manner that at least a part of the first mark is positioned within the viewable range area; and
display on the display apparatus the second mark indicating the unviewable vehicle in such a manner that the second mark is positioned outside of the viewable range area.
